(19) United States
(12) Patent Application Publication
(10) Pub. No.: US 2012/0188460 A1
(43) Pub. Date: Jul. 26, 2012

(54) SYSTEM AND METHOD FOR DYNAMIC VIDEO MODE SWITCHING

(75) Inventors: Franco Eulogio Mau, San Jose, CA (US); Sangyong Park, Castro Valley, CA (US); Anita Chowdhry, Saratoga, CA (US)

(73) Assignee: nComputing Inc., Redwood City, CA (US)

(21) Appl. No.: 13/011,221

(22) Filed: Jan. 21, 2011

(51) Int. Cl. G09G 5/36; H04N 9/64

(52) U.S. Cl. 348/715; 345/545; 345/549; 348/E09.037

(57) ABSTRACT

The video output system in a computer system reads pixel information from a frame buffer to generate a video output signal. However, the video output system must often compete with other memory users in order to access a frame buffer in a shared memory system. When memory bandwidth resources are limited, the performance of a computer system will suffer. To reduce the performance drop, a dynamic color mode switching system has been introduced. The dynamic color mode switching system detects when memory bandwidth resources are limited and then instructs the video output system to switch to a color mode that reduces the amount of reads from the memory system without any user intervention.

### TECHNICAL FIELD

The present application relates to the field of digital video. In particular, but not by way of limitation, the present application discloses techniques for dynamically switching between different digital video modes.

### BACKGROUND

Engineering is a practice that heavily involves weighing different options and making trade-offs. This is expressed in the common engineering anecdote, “Do you want the new product design to be cheap, fast, or good? Pick any two.” which points out that trade-offs will have to be made when engineering a product. For example, if one wishes to quickly make a good product, one will have to use expensive components. If one wishes to quickly make an inexpensive product, the product quality will be low. If one wishes to make a high quality but inexpensive product, it will take time to come up with a good design and then further optimize that design.

In computer engineering, the same principle applies. One can quickly design a high-quality computer system but this will require combining many expensive readily available circuit components and combining them in a non-optimized manner. One can quickly design an inexpensive computer system but the quality and performance of the computer system will be low. In order to design a good efficient computer system, it will take some time to optimize the computer circuit design.

One component to any computer system is a short-term memory system. The short-term memory system stores data when the computer system is operating. There are many different metrics for a memory system such as the size in bits, the size in physical dimensions, the latency period (the time required to obtain a response to a memory request), the memory bandwidth (the amount of data that may be stored or retrieved per unit of time), the memory cost, and the power usage. Since every computer system requires a memory system, it would be desirable to optimize the design of a memory system for a computer system.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1A illustrates a diagrammatic representation of machine in the example form of a computer system within which a set of instructions, for causing the machine to perform any one or more of the methodologies discussed herein, may be executed.

FIG. 1B illustrates a conceptual diagram of one example embodiment of a thin-client environment.

FIG. 1C illustrates a block diagram of a thin-client terminal system coupled to a thin-client server computer system in accordance with an example embodiment.

FIG. 2A illustrates the contents of a 24-bit True-Color pixel in accordance with an example embodiment.

FIG. 2B illustrates a 32-bit data item with a 24-bit digital True-Color pixel and padding data in accordance with an example embodiment.

FIG. 2C illustrates the contents of a 16-bit High-Color pixel in accordance with an example embodiment.

FIG. 2D illustrates the contents of an 8-bit byte containing least significant bit information to supplement the High-Color pixel of FIG. 2C to create a True-Color pixel in accordance with an example embodiment.

FIG. 3A illustrates a packed True-Color frame buffer organization in accordance with an example embodiment.

FIG. 3B illustrates a holey True-Color frame buffer organization in accordance with an example embodiment.

FIG. 3C illustrates a packed High-Color frame buffer organization in accordance with an example embodiment.

FIG. 4A illustrates a computer system with a frame buffer having True-Color organization in accordance with an example embodiment.

FIG. 4B illustrates the computer system of FIG. 4A after the frame buffer has been converted into a High-Color organization in accordance with an example embodiment.

FIG. 5A illustrates a High-Color frame buffer as part of a split frame buffer system in accordance with an example embodiment.

FIG. 5B illustrates a True-Color least significant bits frame buffer as part of a split frame buffer system in accordance with an example embodiment.

FIG. 6A illustrates a computer system with a split frame buffer operating in True-Color mode by accessing both frame buffers in accordance with an example embodiment.

FIG. 6B illustrates the computer system of FIG. 6A with a split frame buffer operating in High-Color mode by only accessing the High-Color frame buffer in accordance with an example embodiment.

FIG. 7 conceptually illustrates the operation of a pseudo True-Color frame buffer in accordance with an example embodiment.

### DETAILED DESCRIPTION

The following detailed description includes references to the accompanying drawings, which form a part of the detailed description. The drawings show illustrations in accordance with example embodiments. These embodiments, which are also referred to herein as “examples,” are described in enough detail to enable those skilled in the art to practice the invention. It will be apparent to one skilled in the art that specific details in the example embodiments are not required in order to practice the present invention. For example, although the example embodiments are mainly disclosed with reference to the True-Color and High-Color video modes, the teachings of the present disclosure can be used with other video modes. Furthermore, the present disclosure describes certain embodiments for use within thin-client terminal systems but the disclosed technology can be used in many other applications. The example embodiments may be combined, other embodiments may be utilized, or structural, logical and electrical changes may be made without departing from the scope what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Small Computer Systems

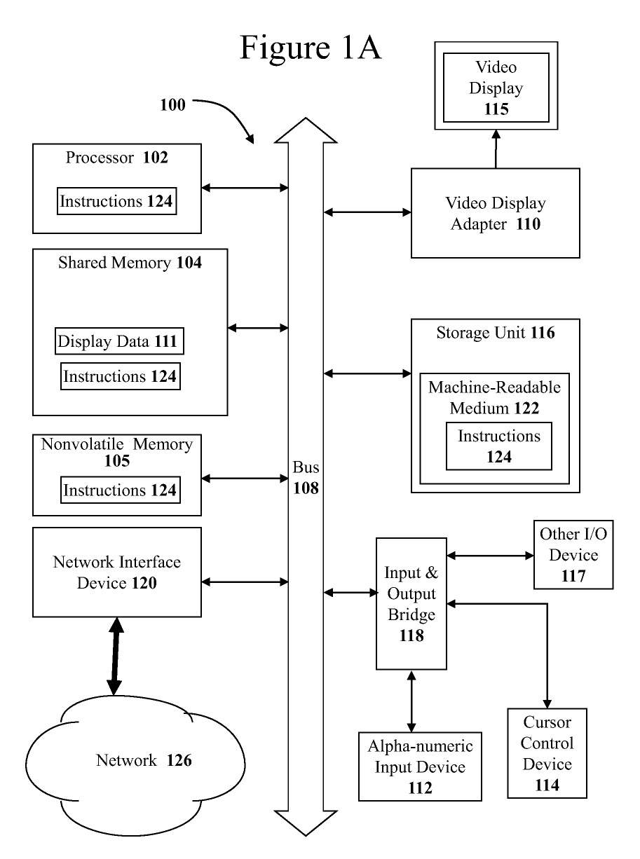

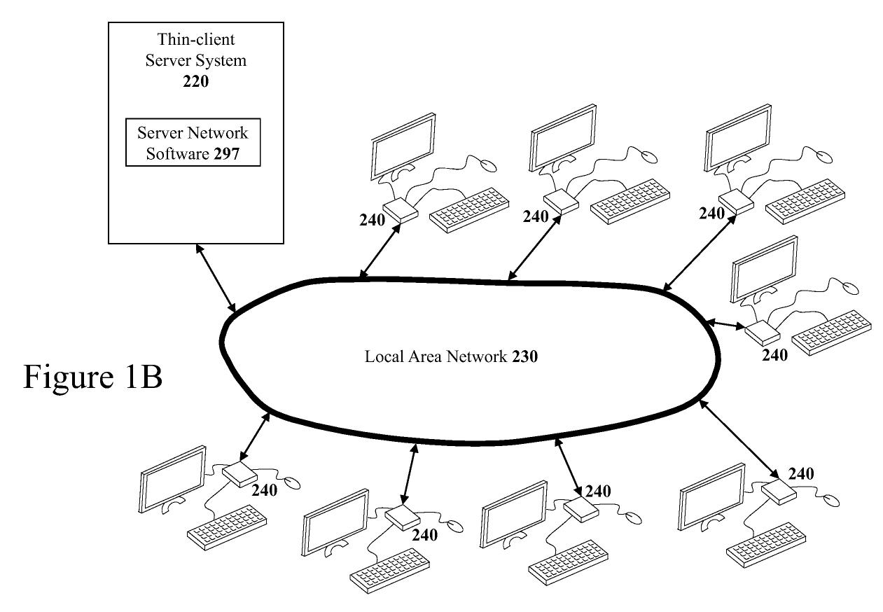

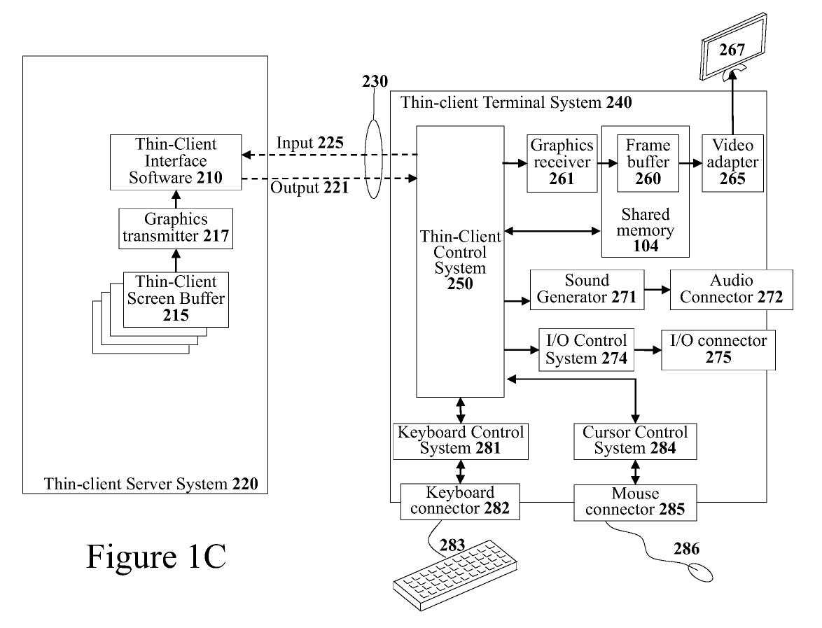

The present disclosure concerns computer systems. FIG. 1A illustrates a diagrammatic representation of a machine in the example form of a computer system 100 that may be used to implement portions of the present disclosure. Within computer system 100 there are a set of instructions 124 that may be executed for causing the machine to perform any one or more of the methodologies discussed herein. In a networked deployment, the machine may operate in the capacity of a server machine or a client machine in a client-server network environment, or as a peer machine in a peer-to-peer (or distributed) network environment. The machine may be a tablet PC, a set-top box (STB), a Personal Digital Assistant (PDA), a cellular telephone, a netbook computer, a web appliance, a small personal computer (PC), or any machine capable of executing a set of computer instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the methodologies discussed herein.

The example computer system 100 includes a processor 102 (e.g., a central processing unit (CPU), a graphics processing unit (GPU) or both), and a shared memory 104 that communicate with each other via a bus 108. The computer system 100 may further include a video display adapter 110 that drives a video display system 115 such as a Liquid Crystal Display (LCD) or a Cathode Ray Tube (CRT). The computer system 100 may include data storage systems such as a storage unit 116 and/or a non-volatile memory system 105 such as flash memory. The computer system 100 may also include a network interface device 120 for interfacing with an external wired or wireless data network.

A input and output bridge 118 may provide access to various input and output devices for the user. For example, the example computer system 100 includes human interface devices (HIDs) 112 and 114. HIDs may include devices such as an alphanumeric input device (e.g., a keyboard) and a cursor control device (e.g., a mouse or trackball). Many additional input or output devices such as other I/O device 117 may be coupled to the input and output bridge 118 to provide other input and output features. The input and output bridge 118 may be implemented with an industry standard bus such as the Universal Serial Bus (USB).

In many computer systems, a section of the shared memory 104 is used to store display data 111 that will be accessed by the video display adapter 110 to generate a video signal. This memory is referred to as a frame buffer. Some video display adapters store display data in a dedicated frame buffer located separate from the main memory (such as within the video display adapter 110). However, this application focuses on computer systems that store frame buffer data within a shared memory system that is used by several memory users. Many of the other subsystems of the computer system 100 will also share the shared memory 104. For example, the processor 102 accesses instructions 124 and data from the shared memory 104. The input & output bridge 118 may also store input & output data 119 in the shared memory 104. The network interface 120 may access the shared memory system 104 for storing and retrieving communication data 113. Thus, the shared memory system 104 is a key resource that must be carefully shared in an equitable manner such that all of the subsystems that use the shared memory can operate properly.

The disk drive unit 116 includes a non-transitory machine-readable medium 122 on which is stored one or more sets of computer instructions and data structures (e.g., instructions 124 also known as ‘software’) embodying or utilized by any one or more of the methodologies or functions described herein. The instructions 124 may also reside, completely or at least partially, within the main memory 104, the non-volatile memory 105, and/or within the processor 102 during execution thereof by the computer system 100. The main memory 104, the non-volatile memory 105, and the processor 102 also constitute machine-readable media.

The instructions 124 may further be transmitted or received over a computer network 126 via the network interface device 120. Such transmissions may occur utilizing any one of a number of well-known transfer protocols such as the well-known File Transport Protocol (FTP).

While the machine-readable medium 122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein, or that is capable of storing, encoding or carrying data structures utilized by or associated with such a set of instructions. The term “machine-readable medium” shall accordingly be taken to include, but not be limited to, solid-state memories, optical media, and magnetic media.

For the purposes of this specification, the term “module” includes an identifiable portion of code, computational or executable instructions, data, or computational object to achieve a particular function, operation, processing, or procedure. A module need not be implemented in software; a module may be implemented in software, hardware/circuitry, or a combination of software and hardware.

Thin-Client Systems

The present disclosure provides methods for improving system performance within small computer systems that have resource limitations. One specific type of small computer system that can benefit from the disclosed system is a thin-client terminal system. FIG. 1B illustrates a conceptual diagram of a thin-client environment. Referring to FIG. 1B, a single thin-client server computer system 220 provides computer processing resources to many individual thin-client terminal systems 240. The thin-client terminal systems 240 are very small computer systems with very limited computer resources such as processing power, memory, and memory bandwidth. In the thin-client environment of FIG. 1B, computer application programs execute on the server computer system 220, and the thin-client terminal systems 240 are used for displaying output and receiving user input.

In the embodiment of FIG. 1B, each of the individual thin-client terminal systems 240 is coupled to the thin-client server computer system 220 using local area network 230 as a bi-directional communication channel. The individual thin-client terminal systems 240 transmit user input (such as key strokes and mouse movements) across the local area network 230 to the thin-client server system 220, and the thin-client server system 220 transmits output information (such as video and audio) across the local area network 230 to the individual thin-client terminal systems 240.

FIG. 1C illustrates a block diagram of an example embodiment of a thin-client server computer system 220 coupled to one (of possibly many) thin-client terminal system 240. The thin-client server computer system 220 and thin-client terminal system 240 are coupled with a bi-directional digital communications channel 230 that may be a serial data connection, an Ethernet connection, or any other suitable bi-directional digital communication means such as the local area network 230 of FIG. 1B.

The thin-client server computer system 220 is equipped with software for handling multiple user sessions. Each of the user sessions may be associated with a thin-client terminal system 240. As illustrated in FIG. 1C, thin-client interface software 210 in thin-client server system 220 supports the thin-client terminal system 240 as well as any other thin-client terminal systems coupled to thin-client server system 220. The thin-client server system 220 keeps track of the display system state of each thin-client terminal system 240 by maintaining a thin-client screen buffer 215 in the thin-client server system 220 for each thin-client terminal system 240. The thin-client screen buffer 215 in the thin-client server system 220 contains representation of what is to be displayed on the video display of the associated thin-client terminal system 240.

The goal of the thin-client terminal system 240 is to provide most or all of the standard input and output features of a personal computer system to the user of the thin-client terminal system 240. However, this goal should be achieved at the lowest possible cost because if a thin-client terminal system 240 is too expensive, a personal computer system could be purchased instead of the inexpensive thin-client terminal system 240. Keeping the costs low can be achieved since the thin-client terminal system 240 will not need the full computing resources or software of a personal computer system. Those features will be provided by the thin-client server system 220 that will interact with the thin-client terminal system 240. The thin-client terminal system 240 only needs to be powerful enough to handle the desired input and output features.

Referring back to FIG. 1C, the thin-client terminal system 240 provides both visual and auditory output using a high-resolution video display system and an audio output system. The high-resolution video display system consists of a graphics update decoder 261, a screen buffer 260 within a shared memory system 104, and a video adapter 265. When changes are made to a representation of a terminal's display in thin-client screen buffer 215 within the server system 220, a graphics transmitter 217 in the server system 220 identifies the changes in the thin-client screen buffer 215 and transmits the screen buffer changes to the associated thin-client terminal system 240.

Within the thin-client terminal system 240, the graphics update receiver 261 applies the same graphical changes made to the associated thin-client screen buffer 215 (in the server 220) to the local screen buffer 260 in a shared memory system 104. Thus, the local screen buffer 260 in the thin-client terminal system 240 contains a copy of the bit-mapped display information in thin-client screen buffer 215. A video adapter 265 reads the video display information out of local screen buffer 260 in the shared memory system 104 and generates a video display signal to drive display system 267.

To minimize the costs of the thin-client terminal system 240, the thin-client terminal system 240 will generally use a shared memory system 104 for providing memory services to all the different subsystems in the thin-client terminal system 240 that need memory services. Each subsystem that accesses the shared memory system 104 will use some of the shared memory system's memory bandwidth and memory storage capacity. Thus, the shared memory system 104 can become a bottleneck within the thin-client terminal system 240 if the shared memory system 104 is not carefully managed.

Computer Display Systems

A video display for a computer system is made up of a matrix of individual pixels (picture elements). Each pixel represents an individual “dot” on the video display device. The resolution of a video display device is defined as the number of pixels displayed on the video display device. For example, a video display monitor with a screen resolution of 800×600 will display a total of 480,000 pixels.

In a color video display system, each individual pixel can be any different color that can be generated by the video display system. Each color pixel is represented in a memory system with a digital value that specifies the pixel's color. The section of a computer memory system that represents pixels to be displayed on a display system is generally known as a “frame buffer”.

The number of different colors that may be represented in memory is specified by the number of data bits assigned to each pixel. The number of bits per pixel is often referred to as the color-depth. A single bit per pixel frame buffer would only be capable of representing a monochrome display (such as black and white). A gray scale display would require a small number of bits to represent different shades of gray. Color pixels are generally represented by the different intensity values for three different colors (such as red, green, and blue) that are combined to create color pixel.

A “High-Color” display system uses 16 bits of data to represent each color pixel with 5 bits of red data, 6 bits of green data, and 5 bits of blue data. A “True-Color” display system represents each color pixel with 24 bits of data comprising 8 bits for each of Red, Green, and Blue (RGB). Thus, True-Color mode is synonymous with “24-bit” mode, and High-Color “16-bit” mode. Due to reduced memory prices and the ability of 24-bit (True-Color) to convincingly display almost any image without much noticeable degradation, most computer systems now use 24-bit True-Color display systems.

To display an image on a video display system, the video display adapter of a computer system fetches pixel data from the frame buffer, interprets the color data, and then generates an appropriate display signal that is sent to a display device such as a liquid crystal display (LCD) panel. Since video display systems are generally refreshed at a very high rate, video display systems are one of the largest users of memory bandwidth in a computer system.

Frame Buffer Organization

Frame buffers generally comprise a contiguous set of memory addresses that each store digital representations of one or more pixels. As set forth above, different frame buffers have different color-depths such that the amount of bits per pixel will vary depending on the color mode that is being used.

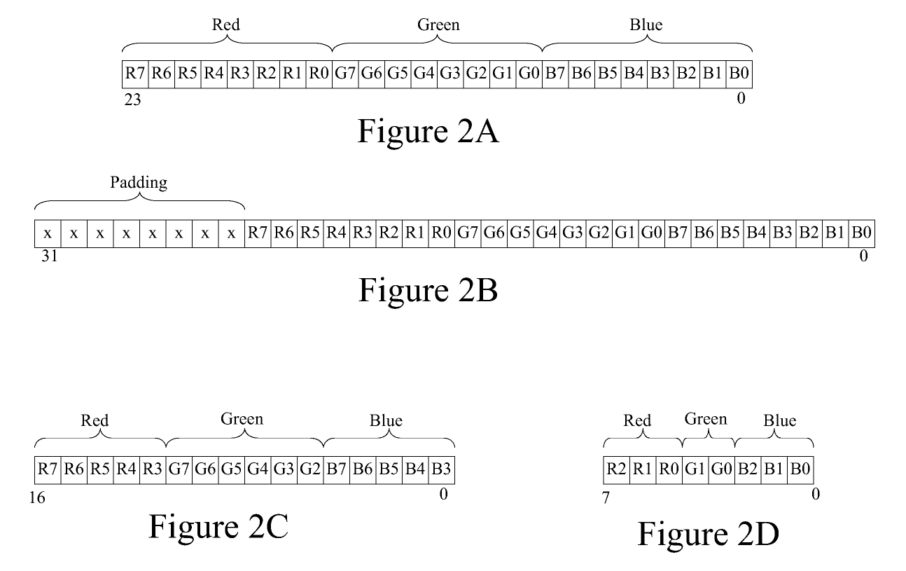

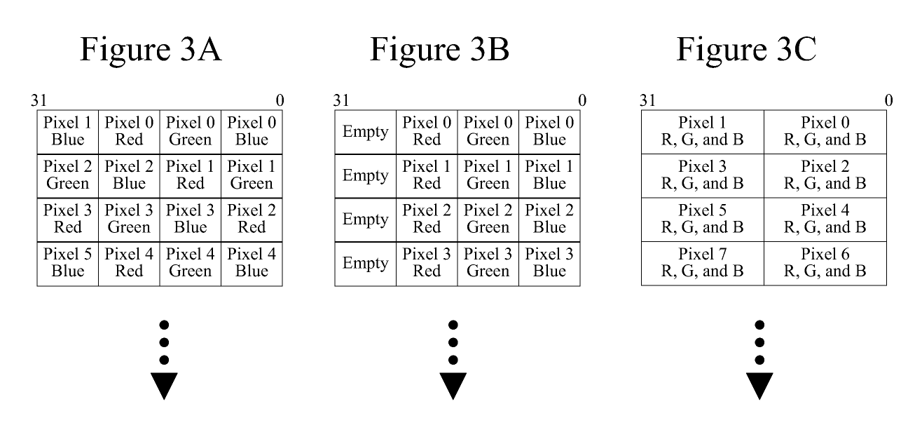

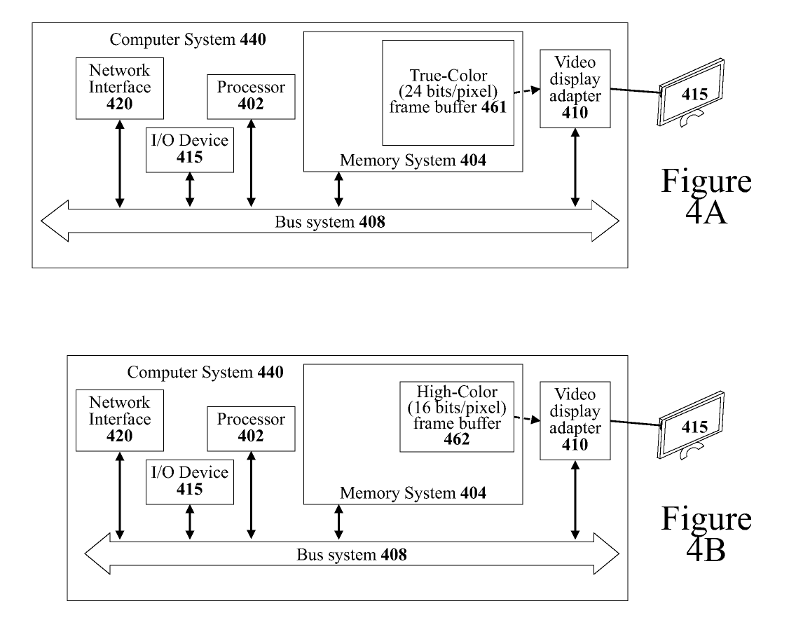

In a True-Color (24-bit) frame buffer, the pixels are generally arranged as a series of three bytes wherein the bytes specify levels of red, green, and blue intensity. FIG. 2A illustrates this particular arrangement of 24 bits to represent a single pixel. The three byte (24-bit) pixels may be arranged in a frame buffer in a packed or holey format. FIG. 3A illustrates an example embodiment of True-Color (24-bit) pixels arranged in a packed format. Note that in the packed format, there is no waste of memory space since the bytes are contiguous. However, since computer systems generally read data in sizes that are powers of two (8 bits, 16, bits, 32 bits, etc.), the computer system will generally not be able to read a single pixel with a single read operation. The data read will either contain only part of a pixel or data from whole pixel with extra data from an adjacent pixel.

To manipulate individual pixels easier, True-Color (24-bit) pixels may be organized in a holey format. FIG. 2B illustrates an example embodiment of a True-Color (24-bit) pixel supplemented with padding bits to make the pixel a full 32 bits wide. In some embodiments, the padding bits (e.g., the extra eight bits) may be used as an alpha value that specifies an amount of transparency for the pixel. When the padded pixels are placed into a frame buffer as illustrated in FIG. 3B, each individual pixel is easily addressable with a single 32-bit read.

High-color pixels only use sixteen bits to represent colors. FIG. 2C illustrates an example embodiment of a 16-bit value used to store red, blue, and green intensity levels for a single High-Color (16-bit) pixel. Since sixteen is not divisible by three, one of the colors is given an extra bit of precision. In an example embodiment, green is selected to receive the extra bit since human eyes are most sensitive to green light. With a High-Color (16-bit) pixel representation, the pixels naturally fit into a packed format as illustrated in FIG. 3C.

Computer video display adapters generally support multiple different bit-depths and resolutions such that different application programs and video display monitors can be supported. When a user switches between True-Color (24-bit) and High-Color (16-bit) pixel modes, this generally requires the video display adapter to stop fetching from the frame buffer pixel data while the pixel data within the frame buffer is re-organized. During this transition, the video display adapter may not generate a video signal such that the video display adapter is not receiving a video display signal that it can decode.

Shared Memory Systems

In many modern computer systems, a frame buffer is stored in a dedicated memory space that is only accessed by software routines and/or hardware generating a pixel image map for display and the video display adapter that reads the pixel image map to generate a video output signal. This dedicated frame buffer arrangement increases the cost and complexity of the computer system but is cost-effective for systems that need to generate very high quality graphics.

In other computer systems, the video display system shares the same main memory system used by the processor for the general operation of the computer system. This technique significantly reduces the cost, the complexity, the number of integrated circuits required, and the power consumption of the computer system. Thus, for mobile computer devices, thin-client systems, system-on-chip (SoC) solutions, cellular telephones, and many other small systems with reduced resources, a shared memory system is generally used.

With a shared memory system, the same memory is accessed for the general computer operation, the generation of a pixel image in a frame buffer for display, the reading of the pixel image in the frame buffer for display, and other uses. All of these different memory operations must share the limited memory size and limited memory bandwidth of the shared memory system. Thus, the performance of a shared memory system will generally not be as good as a system with dedicated memory systems. However, the greatly reduced cost and complexity make this particular engineering trade-off well worth it for mobile computer systems and low cost systems.

Memory bandwidth can be a critical resource in a computer system that uses a shared memory system. For example, consider a portable computer device (such as a cellular telephone, portable videogame, or GPS unit) with video resolution of 480×320. If a True-Color color depth is used (24 bits or 3 bytes per pixel), then the frame buffer has to be at least 480×320×3 bytes=460,800 bytes. This is not a large amount of memory, so memory size is often not an issue. But if one assumes that the device has to display at a refresh rate of 60 Hz (once every 16 ms), the minimum memory bandwidth needed for stable uninterrupted video is 460,800 bytes/16 ms or approximately 27 MB/s. Most memory devices can handle this speed. However, when you consider that the same memory system must also be used for general purpose processing, input, output, and other operations, the memory system bandwidth can become the bottleneck of system performance.

For example, consider a small system that is receiving a stream of data for a full motion digital video clip that is to be displayed. First, an input system (such as a network adapter) that is receiving the stream of data accesses the memory to store the incoming data. Next, a communication protocol stack processes the incoming data stream to extract the video data stream. Next, a video decoder decodes the digitally encoded video to render video frames in a frame buffer. Finally, a digital video adapter reads the video images from the frame buffer and outputs a display on the local display screen. All of these operations require multiple accesses to the shared memory system. Thus, the memory bandwidth limitations of the shared memory system may be severely tested when processing intensive tasks such as video decoding and display are performed. If the memory bandwidth limitations are exceeded, some of the subsystems that access the shared memory system may not be allowed to access the memory system at full speed.

With any computer display system, it is very undesirable to have the video subsystem not receive the image data needed to properly render a display. If a video display adapter cannot access a frame buffer at full speed, a “buffer under-run” may occur such that the video display may become unstable. The user of the computer system may begin to believe that the computer system has malfunctioned even if the computer system is only suffering a temporary memory bandwidth limitation. Thus, the user may reset the computer system, turn the computer system off, or return the computer system to the supplier. These very undesirable outcomes need to be avoided.

Similarly, if a communication system is not allowed to access a memory system at full speed, then that communication system may begin to lose valuable data. If a data stream, such as a video data stream, is being received, the communication system may begin to lose data such that the video decoder may act erratically or freeze up when insufficient video stream data is received.

Thus, to avoid these problems, a small computer system must carefully manage the memory bandwidth consumed by the various subsystems. The most common method of handling a shortage of memory bandwidth is to reduce the performance of application programs running on the system in favor of the video system (and other important subsystems that are viewed as very important such as a communication subsystem). This may cause the computer system to operate slowly.

However, reduced performance of an application program will also greatly annoy a user. Thus, the designer of a computer system having limited resources should strive to prevent situations wherein the memory bandwidth limitations are reached. This generally means that the computer system designer should design the computer system for a “worst case” scenario to ensure that even if the worst case scenario occurs, the performance of the computer system will not suffer due to a lack of memory bandwidth. Even though the actualization of a worst case scenario may be relatively rare, the computer system should be designed with a memory system that will always have enough bandwidth even when the computer system is stressed with a challenging application.

Dynamic Color Mode Switching

Designing a computer system for a worst case scenario will increase the cost of the computer system since extra resources must be available to handle the worst case scenario even though it will occur very rarely. In the competitive consumer electronics market, increased costs must be avoided in order to compete effectively in the marketplace. Thus, it would be desirable to be able to design a computer system that will continue to operate in an acceptable manner even when a challenging application is executed without having to resort to more expensive components. To achieve this goal, the present disclosure introduces the concept of dynamic color mode switching.

Dynamic color mode switching allows a computer system to detect when the memory resources of the system are being severely strained and then automatically switch to a less demanding color mode in order to lessen the memory system requirements of the video display adapter. With the memory requirements from the video display adapter reduced, other applications on the computer system will be able to continue operating with adequate performance. Switching to a less demanding color mode will generally slightly reduce the quality of the output display by introducing some color banding. However, this effect may be mitigated using techniques such as dithering. Furthermore, except for situations where image quality is critical, users tend to be willing to accept a reduced display quality in order to have their applications continue to operate properly.

To implement a dynamic color mode switching system, the computer system must be able to support at least two different color modes and one color mode must use less memory resources than the other color mode. For purposes of this document, the True-Color (24-bit) mode and the High-Color (16-bit) mode will be considered. However, dynamic color mode switching may be implemented with other video parameters.

Referring back to FIG. 3B, in a holey frame buffer arrangement with True-Color (24-bit) pixels, each individual pixel requires 32 bits. To obtain a single pixel, a 32 bit wide read may be performed. Conversely, FIG. 3C illustrates a High-Color (16-bit) pixel frame buffer. When a single 32-bit wide read is performed on the frame buffer of FIG. 3C, the system receives information for two whole pixels. Thus, if system is operating in a True-Color mode when the system becomes short on memory bandwidth, the system could switch from True-Color mode to High-Color mode. This switch from True-Color mode (with a holey arrangement) to High-Color mode would effectively cut the memory bandwidth requirements of the video display adapter in half. In a system that uses a packed True-Color pixel arrangement, the memory bandwidth savings would be one-third.

This color mode change from True-Color to High-Color will slightly reduce the video display output quality. However, the newly available extra memory bandwidth can then be used by the application programs that are running which need the memory bandwidth. In this manner, the user suffers a slight degradation of video image quality but the user's applications continue executing at full speed.

Determining When to Switch Color Modes

As set forth earlier, a well-designed computer system should generally operate well within its limitations. However, as presented with the example of an incoming digital video stream that is decoded and displayed, there are times when the resources of a computer system are stretched such that the dynamic color mode switching system would provide improved application performance. To effectively use the dynamic color mode switching system, a computer system must be able to accurately identify these situations when the resources of a computer system are stretched. Some type of resource monitor system is needed to make such assessments. A software process may be used in some implementations to monitor the computer system resources. However, hardware systems that collect and combine resource usage data may provide more accurate results.

Many different methods may be used to implement a software system that determines when resources are becoming strained such that the dynamic color mode switching system should be triggered. One method of determining when computer resources are being strained is to determine which specific application programs are currently being executed on the computer system. For example, the computer system may have a set of application programs that are known to stress the resources of the system such that the execution of those particular application programs may trigger the dynamic color mode switching system or at least act as a factor.

A hardware-based resource monitor can directly monitor the operation of various circuits and registers. The following paragraphs will disclose various methods that may be used to determine when to trigger the dynamic color mode switching system.

In a video display adapter, there is generally a First-In, First-Out (FIFO) buffer that is filled with pixel data from the frame buffer and used to generate the video output signal. The FIFO buffer is used since it allows the accesses into the frame buffer to be performed in efficient bursts and it allows the video display adapter to continue generating a video output signal if an access into the frame buffer is temporarily displayed. However, when there is a significant strain on memory resources, the FIFO buffer may run low on pixel data and eventually run out of data (a buffer under-run) such that display output will not reflect the data from the frame buffer. To prevent this situation, a specified “water mark” on the FIFO buffer may be used trigger the dynamic color mode switching system. Specifically, after beginning operation and filling the FIFO buffer in the video display adapter, the system may trigger the dynamic color mode switching system if the amount of data in the FIFO ever goes below the specified water mark.

In an alternate system that is less aggressive, the system may simply keep track of the number of times the video system experiences a buffer under-run. If more than a specified number of buffer under-runs occur within a particular unit of time, the system may trigger the dynamic color mode switching system.

If other system performance information is available then more sophisticated triggers can be implemented. It is difficult to precisely measure the usage of memory by a computer system. This is especially true in modern computer systems that tend to be made up of many subsystems that each utilizes the memory. For example, various different execution threads, various different processor cores, various different I/O systems may all access the same shared memory. Each subsystem (when active) will use some memory and some subsystems will use more than others. However, if there is a mechanism to gather real-time information on what parts of the system may be utilizing the memory, a reasonable metric can be made to how much memory bandwidth is still available.

Some computer systems use hardware performance counters to provide an indication of how a system is operating. Hardware performance counters are a set of special-purpose registers built into computer hardware (such as microprocessors) that count various hardware-related activities within the computer system. A resource monitor may rely on hardware performance counters to provide performance analysis. Such hardware counters provide access to a wealth of detailed performance information related to a CPU's functional units, caches, and main memory etc.

Ideally, a resource monitor would monitor several different subsystems of a computer system. For example, suppose a computer system has n different subsystems that each accesses a shared memory. Each subsystem may be assigned bandwidth consumption (bcₙ) number. When a particular subsystem is active, a memory utilization level signal (sₙ) is asserted to a resource monitor system that is responsible for estimating the memory utilization. The utilization signal from each subsystem would be the qualifier for the bandwidth consumption (bcₙ) number for that particular subsystem. Periodically, the monitor system can add up all the bandwidth consumption (bcₙ) numbers to determine whether the computer system continues to have or lacks necessary memory bandwidth. The following pseudo code illustrates an implementation of a resource monitor system that switches between three different color modes.

if ((s₀*bc₀ + s₁*bc₁ + ... + sₙ₋₁*bcₙ₋₁) > threshold(color_mode1)))

do Dynamic_Color_Mode_Switch(color_mode1);

else if ((s₀*bc₀ + s₁*bc₁ + ... + sₙ₋₁*bcₙ₋₁) > threshold(color_mode2)))

do Dynamic_Color_Mode_Switch(color_mode2);

else

do Dynamic_Color_Mode_Switch(color_mode0);

One important consideration for any type of resource monitor used to control dynamic color mode switching is to include an amount of hysteresis in the system. Thus, the resource monitor system should activate the color mode switching system when necessary but it should not continually switch back and forth between color modes on a frequent basis. Thus, techniques such as a countdown timer may be used to keep the system in a particular color mode for a minimum amount of time before it is eligible to switch to another video mode any time soon. This will prevent having the system rapidly switch back and forth between video modes in a manner that will annoy the user. For example, a user may be annoyed by a visual difference in a particular color when the system switches back and forth between a True-Color color mode and a Hi-Color color mode. In an example embodiment, a user may be annoyed by the changing of a shade of blue background from slightly dark to slightly light and vice versa every half a second. The changing shade of blue background may cause a “flashing” effect similar to watching a Cathode Ray Tube (CRT) television while an appliance, such as a hair dryer, is also in operation.

Traditional Color Mode Switching

FIGS. 4A and 4B illustrate block diagrams describing how color mode switching currently is traditionally performed in most computer systems. Referring to FIG. 4A, an example computer system 440 includes a processor 402, an input/output device 415, a main memory system 404, and a video display adapter 410 that are all coupled to a bus system 408 for communicating data. When a user or a program decides to change the color display mode, the user or program instructs the video display adapter 410 to perform the switch. For example, a user may request the video display adapter 410 to switch from True-Color (24-bit) mode to High-Color (16-bit) mode.

To perform the color mode switch, the computer system 440 first reorganizes the contents of the frame buffer 461 in the memory system 404 for the new color mode operation. For example, the system will change from the True-Color organization of FIG. 3A or 3B into the High-Color organization of FIG. 3C. This reorganization may be performed by the processor 402 (under the control of software) or by other hardware.

Once the frame buffer reorganization is complete, the video display adapter 410 then begins interpreting the data in frame buffer in High-Color mode. The computer system 440 running in High-Color (16-bit) mode is illustrated in FIG. 4B. Since the video display adapter 410 will not be able to display video while the memory reorganization is occurring, the video display adapter 410 will cease providing an output signal to the display screen. Once operating in High-Color (16-bit) mode, the computer system 440 consumes both less memory space (since the High-Color frame buffer 462 is smaller than the True-Color frame buffer 461) and less memory bandwidth (since less data needs to be retrieve to display a full image frame). Thus, the other applications that use the main memory system 404 can use this newly available memory space and bandwidth. However, before the computer system 440 switches back to the True-Color (24-bit) mode, the memory space must be returned and the needed memory bandwidth should be available.

When a traditional system changes colors modes as depicted with references to FIGS. 4A and 4B, the video display adapter 410 cannot provide a video signal to the display system 415. Thus, during the time while the frame buffer is reorganized, the display system 415 will go dark or display garbage data. This is an annoying jarring experience for users.

Thus, the traditional method of switching from a True-Color mode to a High-Color mode (and from High-Color back to True-Color) could not be used. Moreover, the time needed by the processor to reorganize the frame buffer in addition to the display system 415 going dark is not ideal.

A Dynamic Color Mode Switching System

To make the transition between the different video color modes acceptable to a user, the dynamic color mode switching system of the present disclosure eliminates the need to reformat the pixel data in the frame buffer on the fly. Instead, the system of the present disclosure adds a second frame buffer that is used in parallel with a High-Color frame buffer.

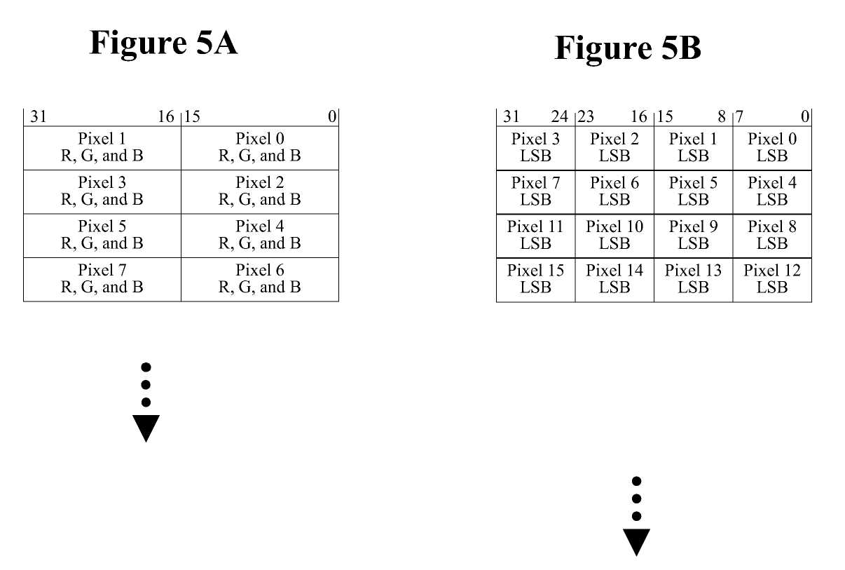

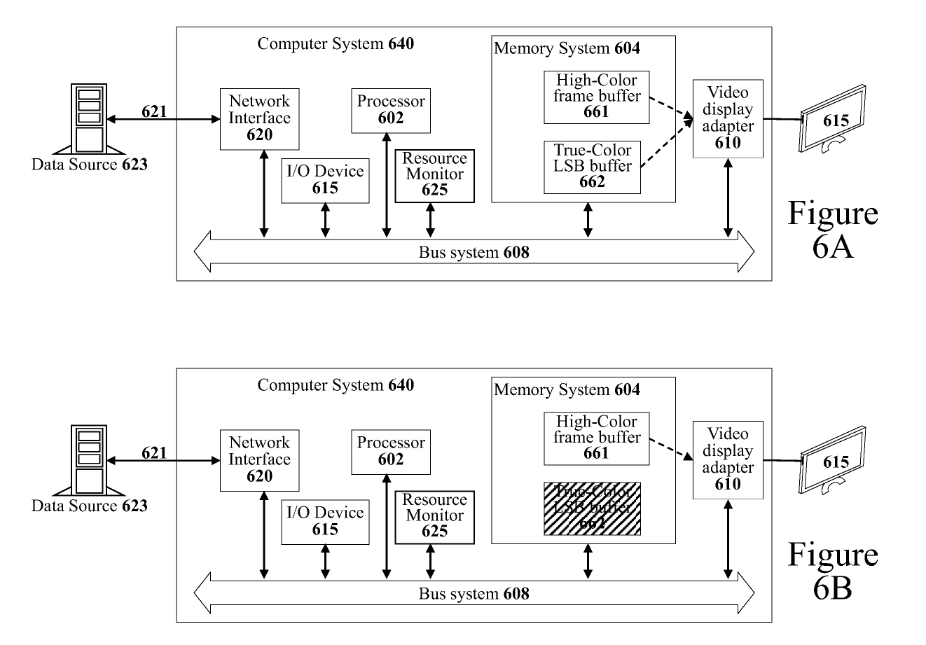

FIGS. 5A and 5B illustrates the two parts of a dual frame buffer organization that may be used in one embodiment of the dynamic color mode switching system implementation. A first frame buffer illustrated in FIG. 5A is a standard High-Color (16-bit) frame buffer that will always by used by the computer system. As illustrated in the High-Color pixel depiction of FIG. 2C, each pixel entry in the High-Color (16-bit) frame buffer contains a 16-bit pixel value with 5 bits of red intensity information, 6 bits of green intensity information, and 5 bits of blue intensity information.

A second frame buffer, illustrated in FIG. 5B, is a “True-Color least significant bits frame buffer” that contains a set of least significant bits (LSB) to compliment the 16-bit pixel values in the High-Color (16-bit) frame buffer to make full 24-bit True-Color pixels. Specifically, each pixel entry in the True-Color LSB frame buffer contains 3 bits of red intensity information, 2 bits of green intensity information, and 3 bits of blue intensity information as illustrated in FIG. 2D. By combining the LSB information from the True-Color LSB buffer with the High-Color pixel information in the High-Color frame buffer, a full True-Color pixel is achieved. Specifically, the R7 to R3, G7 to G2, and B7 to B3 information of FIG. 2C is combined with the R2 to R0, G1 to G0, and B2 to B0 information of FIG. 2D to create a full True-Color pixel such as the True-Color pixel represented in FIG. 2A.

FIG. 6A illustrates an implementation of a computer system with the disclosed dynamic color mode switching system. As illustrated in FIG. 6A, the memory system 604 contains both a High-Color frame buffer 661 and a True-Color LSB frame buffer 662. When the system is operating normally in True-Color mode, the video display adapter 610 will read pixel information from both the High-Color frame buffer 661 and a True-Color LSB frame buffer 662. The pixel data from the two frame buffers is combined in the video display adapter 610 to render True-Color pixels onto the video display screen 615.

A resource monitor program 625 in main memory system 604 tracks the resource usage of the various subsystems in the computer system 640. Note that resource monitor program 625 is just one particular implementation. Other systems may use other means for determining when resources are low such as the “water mark” system that monitors a pixel FIFO buffer in the video display adapter 610. When the resource monitor program 625 determines that memory resources are running low, the resource monitor program 625 can instruct the video display adapter 610 to switch from the True-Color (24-bit) mode to the High-Color (16-bit) mode.

When the video display adapter 610 enters High-Color mode, the video display adapter 610 will only read from the sixteen bits of High-Color pixel data from High-Color frame buffer 661. The pixel data within the True-Color LSB frame buffer 662 will be ignored. By only reading sixteen bits of video data per pixel instead of 24 bits of video data per pixel, the video display adapter 610 will be using a significantly lower amount of memory bandwidth. This will reduce the memory bandwidth requirements of the video display system such that other users of memory bandwidth or subsystems using memory bandwidth may increase memory bandwidth usage.

In one embodiment, the systems that fill the True-Color LSB frame buffer 662 with data will continue operating even though this data will be ignored. (For example, in the thin-client embodiment of FIGS. 1B and 1C, the graphics update receiver 261 will continue refreshing the True-Color LSB frame buffer 662 in the frame buffer 260.) This will allow for an immediate switch back into True-Color mode. However, in other embodiments, the systems that update the data for the True-Color LSB frame buffer 662 will also be turned off such that additional memory bandwidth savings will be achieved. Such implementations will take slightly longer to resume True-Color operation.

In certain embodiments, additional upstream resource savings may also be achieved. For example, in the thin-client environment illustrated in FIGS. 1B and 1C, the thin-client terminal system 240 may be implemented with a dynamic color mode switching system. When a thin-client terminal system 240 switches from a True-Color (24-bit) mode to a High-Color (16-bit) mode, the thin-client terminal system 240 may inform the thin-client server system 220 that only High-Color (16-bit) data is now required for display. This will allow the thin-client server system 220 to conserve network bandwidth by only transmitting 16 bits per pixel display data to the thin-client terminal system 240. The thin-client server system 220 may or may not change the operation of the thin-client screen buffer 215 into a High-Color (16-bit) mode. If the thin-client server system 220 puts the thin-client screen buffer 215 into a High-Color (16-bit) mode then the thin-client server system 220 will conserve CPU cycles and network bandwidth. If thin-client server system 220 allows the thin-client screen buffer 215 to remain in a True-Color (24-bit) mode but will transmit High-Color (16-bit) mode data then the thin-client server system 220 must consume CPU cycles transforming the True-Color (24-bit) data into High-Color (16-bit) data before transmission.

Referring back to FIGS. 6A and 6B, when the particular application activity that consumes a large amount of memory bandwidth subsides, the resource monitor 625 may instruct the video display adapter 610 to resume displaying full True-Color (24-bit/pixel) images. As set forth above, the activities that must occur to resume display of True-Color images will vary depending on the particular implementation.

In implementations wherein the True-Color LSB frame buffer 662 continues receiving the additional true-color pixel information, the video display adapter 610 may immediately resume True-Color mode operation since the True-Color pixel information is available. Thus, the video display adapter 610 can immediately start reading from both the True-Color LSB frame buffer 662 and the High-Color pixel data from the High-Color frame buffer 661 (that the video display adapter 610 had been reading while in High-Color only display mode) such that the combined data can be used to display True-Color images.

In other implementations wherein the display data rendering system stopped updating the True-Color LSB frame buffer 662 with the extra data bits, the display data rendering system must first refill the True-Color LSB frame buffer 662 before resuming True-Color mode operation. If there are upstream sources of data that have stopped providing the True-Color least significant bits needed for the True-Color LSB frame buffer 662, then those upstream data sources must be told to resume sending the True-Color least significant bits needed to fill the True-Color LSB frame buffer 662. For example, to resume True-Color mode operation in the thin-client environment of FIGS. 1B and 1C when the thin-client server system 220 stopped transmitting full True-Color pixel data, the thin-client terminal system 240 would request the thin-client server system 220 to resume sending the full True-Color pixel information. Referring to FIG. 1C, once the graphics update receiver 261 refilled the True-Color LSB frame buffer (not shown in FIG. 1C), the video display adapter 265 may resume reading from the True-Color LSB frame buffer and restart rendering a True-Color image display. Specifically, referring back to FIG. 6A, the video display adapter 610 in the thin-client terminal would resume reading from the True-Color LSB frame buffer 662 (and the high-color frame buffer 661) in order to render a True-Color image on the local display system 615.

With most digital video display systems, the changing of color modes requires the video display system to stop operating, reorganize the frame buffer data, and then resume video display operation. This change may be disconcerting to a user of the system since the user's video display screen may go dark or display some garbage data for a few moments before resuming operation in the new color mode after the frame buffer has been reorganized. With the dynamic color mode switching system of the present disclosure, there will be only minimal disruptive video display behavior since no time is required to reorganize the frame buffer. Instead, the user just experiences a nearly seamless change from the High-Color video output mode to the True-Color video output mode.

To prevent the undesired artifact of ‘screen tearing’ where one portion of the display does not match another portion of the display screen, the video display adapter 610 may wait until the next vertical synchronization (VSYNC) occurs before switching back to True-Color mode. This will prevent a particular frame from being displayed with a first portion in High-Color and a second portion in True-Color (or vice versa).

As set forth earlier, there should be some hysteresis implemented within the dynamic color mode switching system. Such hysteresis will prevent the system from oscillating back and forth between the High-Color and True-Color modes. A typical user would rather view a sustained High-Color output instead of having a system that rapidly switches back and forth between a High-Color display mode and a True-Color display mode.

The splitting from the single True-Color frame buffer 461 of FIG. 4A into the split frame buffer system with frame buffers 661 and 662 as in FIG. 6A is relatively easy. The following pseudo code describes how to split a single True-Color frame buffer into the split frame buffers (the High-Color frame buffer and the least-significant bits frame buffer). Note that the pointers in the pseudo code are addressed in bytes:

for (pixel=0; pixel<total_pixel_resolution; pixel++) {

| red = (fb_ptr & 0xf80000) >> 8; | |
|---|---|
| green = (fb_ptr & 0xfc00) >> 5; | |
| blue = (fb_ptr & 0xf8) >> 3; | |
| high_ptr = (red \| green \| blue); | |
| *high_ptr += 2; | |
| red = (fb_ptr & 0x70000) >> 11; | |
| green = (fb_ptr & 0x300) >> 5; | |
| blue = (fb_ptr & 0x7); | |
| low_ptr = (red \| green \| blue); | |
| *low_ptr += 1; | |
| if (packed) | *fb_ptr += 3; |
| if (holey) | *fb_ptr += 4; |

}

Pseudo True-Color Mode Handling

Other video modes exist besides the High-Color mode and True-Color mode that have been focused upon in this document. For example, in the U.S. patent application Ser. No. 12/207,389 (“SYSTEM AND METHOD FOR LOW BANDWIDTH DISPLAY INFORMATION TRANSPORT”), filed Sep. 9, 2008 (which is hereby incorporated by reference in its entirety), a pseudo True-Color display mode was disclosed.

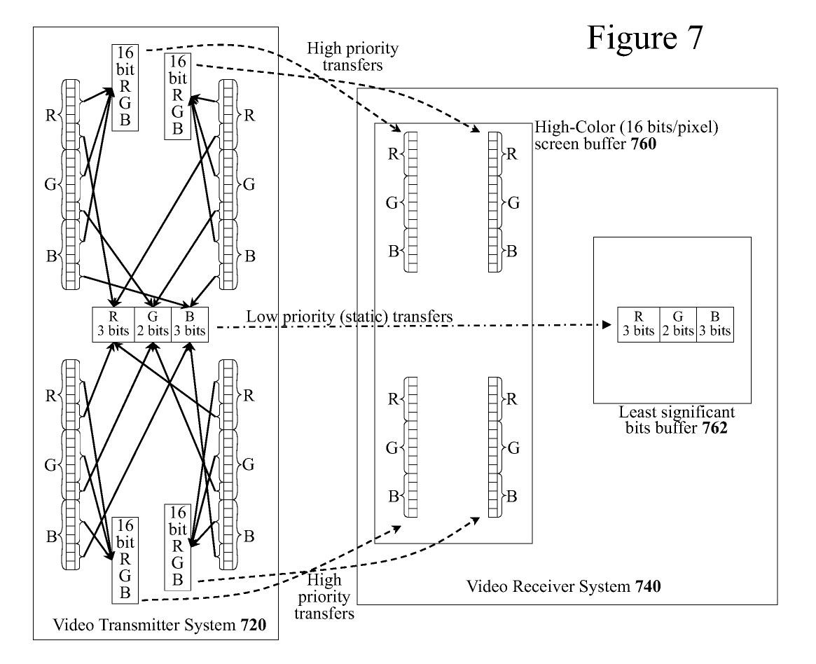

In the pseudo True-Color mode, groups of four adjacent bits share the same least significant bits. This technique increases the image quality over a High-Color display system with only minimal additional bandwidth requirements to transmit those additional least significant bits. FIG. 7 conceptually illustrates how the pseudo True-Color mode system is illustrated.

Referring to FIG. 7, a True-Color two-by-two (2×2) patch of source pixels is illustrated. Each True-Color source pixel is represented by 24 bits: 8 bits of red, 8 bits of green, and 8 bits of blue. To transmit the source pixel information from a video transmitter system 720 to a pseudo True-Color receiver system 740, the most significant bits of each pixel are transmitted (generally in a high-priority basis) in order to create a High-Color representation of each individual pixel in a High-Color screen buffer 760 of the video receiving system. The receiver system 740 can then generate a High-Color image. However, to improve the image, additional information may be transmitted to generate a pseudo True-Color image.

Referring again to FIG. 7, the least significant color bits of the two-by-two (2×2) patch of source pixels are averaged together to create an 8 bit additional color representation for the two-by-two (2×2) patch of source pixels. In one embodiment, the four 3-bit red bits are averaged into a 3-bit average red value, the four 2-bit green bits are averaged into a 2-bit average green value, and the four 3-bit blue bits are averaged into a 3-bit average blue value. This 8-bit value may then be transmitted for each two-by-two (2×2) patch of pixels (often on a lower priority basis) and stored in a least significant bits buffer 762. The receiver system 740 can then generate a pseudo True-Color image by reading from both the High-Color screen buffer 760 and the least significant bits buffer 762 in a similar manner to the computer system 640 of FIGS. 6A and 6B.

One of the key features of the dynamic color mode switching system is its seamless ability to switch between various color modes automatically. Thus, switching between the Pseudo True-Color mode and High-Color mode is similar to switching between True-Color mode and High-Color mode. Basically, the system can just ignore the least significant bits buffer 762.

Since there are fewer low order bits in the least significant bits buffer 762 of the Pseudo True-Color system, the bandwidth savings for a Pseudo True-Color system will be smaller than with full True-Color system. The bandwidth required to transport the data will be display screen resolution (width*height), multiplied by the bits per pixel, and multiplied by the times refreshed per second. In equation form:

Bandwidth required=width*height*bits per pixel*refresh rate

The following table lists the bandwidth required to update a display screen with a resolution of 1680 by 1050 that is refreshed at a rate of 60 Hz:

| | | | Bandwidth | |
|---|---|---|---|---|
| | | | Difference | % Drop |
| Color | | | to | to High- |
| mode | Bits per pixel | Bandwidth | High-Color | Color |
| True- | 3 bytes per pixel | ~317.5 MB/s | ~105.5 MB/s | 33% |
| Color | | | | |
| Pseudo | 2.25 bytes per pixel | ~238 MB/s | ~26 MB/s | 11% |
| true | | | | |
| High- | 2 bytes per pixel | ~212 MB/s | 0 | 0 |
| Color | | | | |

As illustrated in the above table, dropping from True-Color to High-Color results in a 33% savings of bandwidth whereas dropping from Pseudo True-Color mode to High-Color mode only results in an 11% drop in bandwidth. However, when dealing with high resolution screen displays, even an 11% drop in bandwidth requirements is a hefty 25 Megabytes per second drop in bandwidth.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description. The scope of the claims should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. The abstract is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

We claim:

1. A digital video display system, said digital video display system comprising:
a first memory buffer, said first memory buffer comprising a set of most significant bits for a set of pixels;
a second memory buffer, said second memory buffer comprising a set of least significant bits for said set of pixels;
a video output generator, said video output generator for reading pixel data from said memory buffers and generating video output; and
a resource monitor, said resource monitor instructing said video output generator to read from said first memory buffer and said second memory buffer when high quality video is desired, and said resource monitor instructing said video output generator to read from said first memory buffer but not said second memory buffer when memory resources are scarce.

2. The digital video display system of claim 1, said digital video display system further comprising a plurality of resource reporting units, each of said resource reporting units providing resource usage information to said resource monitor.

3. The digital video display system of claim 1, said digital video display system further comprising a frame buffer splitter, said frame buffer splitter converting a unified frame buffer into said first memory buffer and said second memory buffer.

4. The digital video display system of claim 1, wherein said first memory buffer comprises a High-Color frame buffer.

5. The digital video display system of claim 4, wherein said set of least significant bits of said second memory buffer are combinable with said set of most significant bits of said High-Color frame buffer to form a set of complete True-Color pixel information.

6. The digital video display system of claim 4, wherein said set of least significant bits of said second memory buffer comprises a set of averaged least significant bits, said set of average least significant bits being combinable with said set of most significant bits of said High-Color frame buffer to form a set of pseudo True-Color pixel information.

7. The digital video display system of claim 1, wherein said first memory buffer and said second memory buffer are part of a shared memory system.

8. The digital video display system of claim 7, wherein an input/output subsystem uses said shared memory system.

9. A method of reading pixel information in a computer system, said method comprising:
detecting a memory resource usage in said computer system with a resource monitor;
reading pixel information from both a first memory buffer comprising a set of most significant bits for a set of pixels and a second memory buffer comprising a set of least significant bits for said set of pixels when said memory resource usage is low; and
reading pixel information from only from said first memory buffer when said memory resource usage is high.

10. The method of reading pixel information in a computer system of claim 9, said method further comprising receiving memory usage information from a plurality of resource reporting units in said resource monitor.

11. The method of reading pixel information in a computer system of claim 9, said method further comprising converting a unified frame buffer into said first memory buffer and said second memory buffer.

12. The method of reading pixel information in a computer system of claim 9, wherein said first memory buffer comprises a High-Color frame buffer.

13. The method of reading pixel information in a computer system of claim 12, wherein said set of least significant bits of said second memory buffer are combinable with said set of most significant bits of said High-Color frame buffer to form a set of complete True-Color pixel information.

14. The method of reading pixel information in a computer system of claim 12, wherein said set of least significant bits of said second memory buffer comprises a set of averaged least significant bits, said set of averaged least significant bits being combinable with said set of most significant bits of said High-Color frame buffer to form a set of pseudo True-Color pixel information.

15. The method of reading pixel information in a computer system of claim 9, wherein said first memory buffer and said second memory buffer are part of a shared memory system.

16. The method of reading pixel information in a computer system of claim 15, wherein an input/output subsystem uses said shared memory system.

17. A method of reading pixel information in a computer system, said method comprising:
detecting a memory resource usage in said computer system with a resource monitor;
reorganizing a high-quality frame buffer into a lower-quality frame buffer when said memory resource usage is high; and
reorganizing said lower-quality frame buffer into said high-quality frame buffer when said memory resource usage is low.

18. The method of reading pixel information in a computer system of claim 17, said method further comprising receiving memory usage information from a plurality of resource reporting units in said resource monitor.

19. The method of reading pixel information in a computer system of claim 17, wherein said high-quality frame buffer comprises a True-Color frame buffer.

20. The method of reading pixel information in a computer system of claim 17, wherein said frame buffers are part of a shared memory system that is shared with other subsystems in said computer system.
